(19) United States
(12) Patent Application Publication
(10) Pub. No.: US 2014/0076809 A1
(43) Pub. Date: Mar. 20, 2014

(54) APPARATUS FOR RECOVERY OF MAGNETIC NANOPARTICLES AND APPARATUS AND METHOD FOR FORWARD OSMOSIS MEMBRANE FILTRATION USING THE SAME

(71) Applicants: Seock Heon LEE, Seoul (KR); Young Beom YU, Seoul (KR); Kyoung Ja WOO, Seoul (KR); Seong Pil JEONG, Seoul (KR); Woo Hyeon RHEE, Seoul (KR)

(72) Inventors: Seock Heon LEE, Seoul (KR); Young Beom YU, Seoul (KR); Kyoung Ja WOO, Seoul (KR); Seong Pil JEONG, Seoul (KR); Woo Hyeon RHEE, Seoul (KR)

(73) Assignee: Korea Institute of Science and Technology, Seoul (KR)

(21) Appl. No.: 13/622,527

(22) Filed: Sep. 19, 2012

(51) Int. Cl. C02F 1/44

(52) U.S. Cl. CPC C02F 1/445; B82Y 25/00
USPC 210/638; 210/222; 210/223; 210/648; 977/773; 977/902

(57) ABSTRACT

The present disclosure relates to an apparatus for recovery of magnetic nanoparticles, which recovers and reuses magnetic nanoparticles in a forward osmosis membrane filtration process using magnetic nanoparticles as a draw solute so as to maintain a consistent concentration of the draw solution and separate and discharge high-purity fresh water, and apparatus and method for forward osmosis membrane filtration using the same.

### BACKGROUND

1. Field

The present disclosure relates to an apparatus for recovery of magnetic nanoparticles and apparatus and method for forward osmosis membrane filtration using the same, and more particularly, to an apparatus for recovery of magnetic nanoparticles, which recovers and reuses magnetic nanoparticles in a forward osmosis membrane filtration process using magnetic nanoparticles as a draw solute so as to maintain a consistent concentration of the draw solution and separate and discharge high-purity fresh water, and apparatus and method for forward osmosis membrane filtration using the same.

2. Description of the Related Art

The forward osmosis membrane filtration represents a technique where sewage/wastewater and a draw solution are disposed with a forward osmosis membrane being interposed therebetween and then forward osmosis is induced by the draw solution to separate the sewage/wastewater into concentrated waste water and fresh water. In the forward osmosis membrane filtration, the draw solution is reused, and for the reuse of the draw solution, a process of separating the draw solution from the fresh water is required.

The draw solution used for the forward osmosis membrane filtration process includes an aqueous NaCl solution, NH₃/CO₂ or the like, and recently a solution where magnetic nanoparticles are dispersed is also used. In the case of using magnetic nanoparticles as a draw solute, if magnetic nanoparticles are recovered and reused, the costs for the membrane filtration process may be reduced. However, regarding the case of using magnetic nanoparticles as a draw solute in the forward osmosis membrane filtration process, the technique of recovering magnetic nanoparticles is not yet proposed.

However, among the conventional art, US 2007/0056912 proposes a technique of separating magnetic particles from fluid, and magnetic bodies are attached to both sides of a vessel to recover magnetic particles from the flow flowing in the vessel. However, in this technique, since the magnetic body is fixed to one side of the vessel to always apply a consistent magnetic field, it is difficult to control the recovery of magnetic particles in time series, and so the above technique may not be easily applied to the forward osmosis membrane filtration process.

### SUMMARY

The present disclosure is directed to providing an apparatus for recovery of magnetic nanoparticles, which recovers and reuses magnetic nanoparticles in a forward osmosis membrane filtration process using magnetic nanoparticles as a draw solute so as to maintain a consistent concentration of the draw solution and separate and discharge high-purity fresh water, and apparatus and method for forward osmosis membrane filtration using the same.

In one aspect, there is provided an apparatus for recovery of magnetic nanoparticles, which includes: a draw solution transfer pipe for transferring a solution containing magnetic nanoparticles; and a magnetic field applying unit provided at the circumference of the draw solution transfer pipe to selectively apply a magnetic field thereto so that the magnetic nanoparticles in the draw solution are attached to or detached from the draw solution transfer pipe, wherein the magnetic field applying unit includes a magnetic body case provided to closely adhere to an outer wall of the draw solution transfer pipe and a magnetic body provided in the magnetic body case, and wherein the magnetic body is provided at a location adjacent to the draw solution transfer pipe to attach the magnetic nanoparticles in the draw solution to an inner wall of the draw solution transfer pipe or provided at a location apart from the draw solution transfer pipe to detach the magnetic nanoparticles attached to the inner wall of the draw solution transfer pipe.

The apparatus may selectively perform a fresh water discharging process of supplying a draw solution to the draw solution transfer pipe in a state where a magnetic field is applied to the draw solution transfer pipe so as to attach magnetic nanoparticles in the draw solution to the inner wall of the draw solution transfer pipe and discharge the fresh water, and a magnetic nanoparticles recovering process for supplying a draw solution to the draw solution transfer pipe in a state where a magnetic field applied to the draw solution transfer pipe is removed so as to recover the magnetic nanoparticles.

In another aspect, there is provided an apparatus for forward osmosis membrane filtration using a magnetic nanoparticles recovery apparatus, which includes: a forward osmosis membrane unit for separating waste water into fresh water and concentrated waste water by using magnetic nanoparticles as a draw solute of a draw solution; a draw solution concentration adjusting bath for receiving a diluted draw solution from the forward osmosis membrane unit, putting magnetic nanoparticles into the diluted draw solution to adjust a concentration of the draw solution, and re-supplying the draw solution to a draw solution bath of the forward osmosis membrane unit; and a magnetic nanoparticles recovery apparatus for receiving a diluted draw solution from the draw solution concentration adjusting bath, separating the draw solution into magnetic nanoparticles and fresh water, recovering the separated magnetic nanoparticles, and supplying the recovered magnetic nanoparticles to the draw solution concentration adjusting bath.

The magnetic nanoparticles recovery apparatus may include: a draw solution transfer pipe for transferring a diluted draw solution supplied from the draw solution concentration adjusting bath; and a magnetic field applying unit provided at the circumference of the draw solution transfer pipe to selectively apply a magnetic field thereto so that the magnetic nanoparticles in the draw solution are attached to or detached from the draw solution transfer pipe.

The magnetic field applying unit may include a magnetic body case provided to closely adhere to an outer wall of the draw solution transfer pipe and a magnetic body provided in the magnetic body case, and the magnetic body may be provided at a location adjacent to the draw solution transfer pipe to attach the magnetic nanoparticles in the draw solution to an inner wall of the draw solution transfer pipe or provided at a location apart from the draw solution transfer pipe to detach the magnetic nanoparticles attached to the inner wall of the draw solution transfer pipe.

In the magnetic body case, the magnetic body may be provided at a location adjacent to the draw solution transfer pipe or at a location apart from the draw solution transfer pipe. In addition, the magnetic body may be fixed in the magnetic body case, the magnetic body case may rotate by 180 degrees, and the rotation of the magnetic body case may allow the magnetic body to be located adjacent to the draw solution transfer pipe or be located apart from the draw solution transfer pipe.

A fresh water discharge line for discharging fresh water obtained by removing the magnetic nanoparticles from the draw solution and a magnetic nanoparticles collection line for recovering the magnetic nanoparticles may be further provided at one side of the draw solution transfer pipe. In addition, an ion exchange resin may be further provided at the rear end of the fresh water discharge line to remove magnetic ion remaining in the fresh water.

The magnetic body may be configured so that the magnetic body has relatively lower magnetic intensity at an inlet portion of the draw solution transfer pipe and relatively higher magnetic intensity at a discharging portion of the draw solution transfer pipe.

In still another aspect, there is provided a method for forward osmosis membrane filtration using a magnetic nanoparticles recovery apparatus, which includes: performing a forward osmosis membrane filtration process by means of a forward osmosis membrane unit which uses magnetic nanoparticles as a draw solute; supplying a draw solution diluted by the forward osmosis membrane filtration process to a draw solution concentration adjusting bath; supplying the draw solution of the draw solution concentration adjusting bath to a magnetic nanoparticles recovery apparatus, and separating the draw solution into fresh water and magnetic nanoparticles by means of the magnetic nanoparticles recovery apparatus; and adjusting a concentration of the draw solution by putting the magnetic nanoparticles recovered by the magnetic nanoparticles recovery apparatus into the draw solution concentration adjusting bath, and supplying the adjusted draw solution to a draw solution bath of the forward osmosis membrane unit.

The magnetic nanoparticles recovery apparatus may include a draw solution transfer pipe and a magnetic field applying unit, and the separating of the draw solution into fresh water and magnetic nanoparticles by means of the magnetic nanoparticles recovery apparatus may include: a fresh water discharging process of supplying a draw solution from the draw solution concentration adjusting bath to the draw solution transfer pipe in a state where a magnetic field is applied to the draw solution transfer pipe so as to attach magnetic nanoparticles in the draw solution to the inner wall of the draw solution transfer pipe and discharge the fresh water; and a magnetic nanoparticles recovering process for supplying a draw solution from the draw solution concentration adjusting bath to the draw solution transfer pipe in a state where a magnetic field applied to the draw solution transfer pipe is removed so as to recover the magnetic nanoparticles.

The apparatus for recovery of magnetic nanoparticles according to the present disclosure and the apparatus and method for forward osmosis membrane filtration using the same give the following effects.

By using the apparatus for recovery of magnetic nanoparticles, which selectively applies a magnetic field, it is possible to recover magnetic nanoparticles and separate and discharge fresh water together, and the concentration of the draw solution may be maintained consistently even though the draw solution is diluted during the forward osmosis membrane filtration process by putting the recovered magnetic nanoparticles into a draw solution.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a diagram showing an apparatus for forward osmosis membrane filtration, which uses an apparatus for recovery of magnetic nanoparticles according to an embodiment of the present disclosure;

FIG. 2a is a schematic view showing a magnetic body provided at a location adjacent to a solution transfer pipe to discharge fresh water, in the apparatus for recovery of magnetic nanoparticles according to an embodiment of the present disclosure;

FIG. 2b is a plane view showing the magnetic body provided at a location adjacent to the solution transfer pipe, in the apparatus for recovery of magnetic nanoparticles according to an embodiment of the present disclosure;

FIG. 3a is a schematic view showing a magnetic body provided at a location apart from the solution transfer pipe to recover magnetic nanoparticles, in the apparatus for recovery of magnetic nanoparticles according to an embodiment of the present disclosure;

FIG. 3b is a plane view showing the magnetic body provided at a location apart from the solution transfer pipe, in the apparatus for recovery of magnetic nanoparticles according to an embodiment of the present disclosure; and

FIG. 4 is a flowchart for illustrating a method for forward osmosis membrane filtration, which uses an apparatus for recovery of magnetic nanoparticles according to an embodiment of the present disclosure.

[Detailed Description of Main Elements]

| | |
|---|---|
| 110: forward osmosis membrane unit | 111: forward osmosis |
| | membrane |
| 112: waste water bath | 113: draw solution bath |
| 120: draw solution concentration adjusting bath | |
| 130: magnetic nanoparticles recovery apparatus | |
| 131: draw solution transfer pipe | 132: magnetic body case |
| 133: magnetic body | 140: ion exchange resin |

### DETAILED DESCRIPTION

In the present disclosure, an apparatus for forward osmosis membrane filtration which uses magnetic nanoparticles as a draw solute recovers magnetic nanoparticles by means of a predetermined apparatus for recovery of magnetic nanoparticles (or, a magnetic nanoparticles recovery apparatus), and maintains a consistent concentration of the draw solution by using the recovered magnetic nanoparticles. In addition, as the magnetic nanoparticles are recovered, high-purity fresh water may be separated. Hereinafter, an apparatus for recovery of magnetic nanoparticles according to an embodiment of the present disclosure and apparatus and method for forward osmosis membrane filtration using the same will be described in detail with reference to the accompanying drawings.

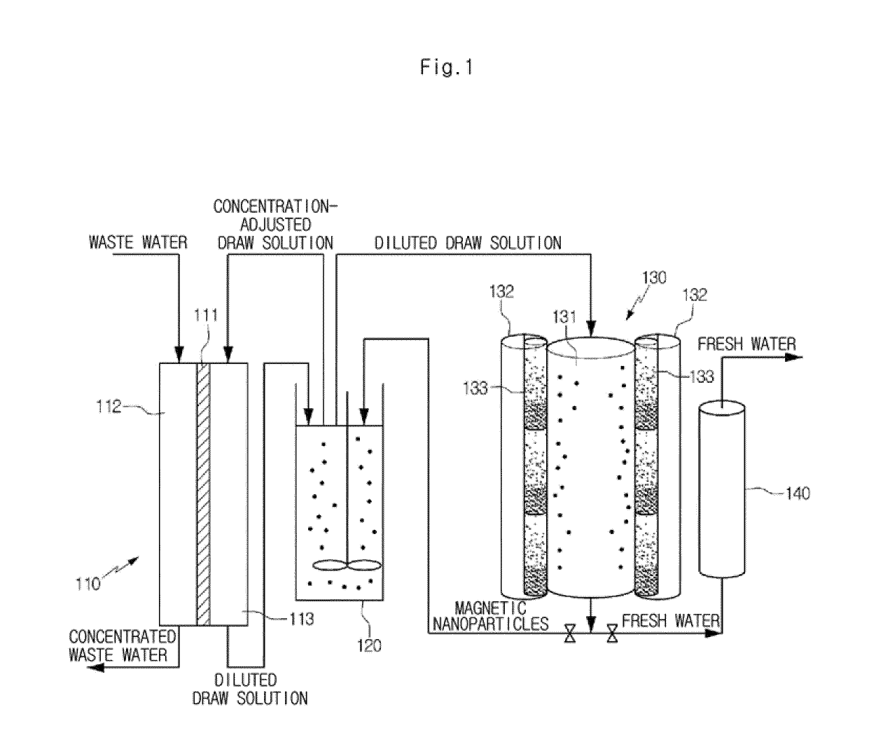

Referring to FIG. 1, an apparatus for forward osmosis membrane filtration using a magnetic nanoparticles recovery apparatus according to an embodiment of the present disclosure includes a forward osmosis membrane unit 110, a draw solution concentration adjusting bath 120 and a magnetic nanoparticles recovery apparatus 130.

The forward osmosis membrane unit 110 separates waste water into fresh water and concentrated waste water by using osmotic pressure and includes a waste water bath 112, a forward osmosis membrane 111 and a draw solution bath 113. The forward osmosis membrane 111 is provided between the waste water bath 112 and the draw solution bath 113, and a draw solution is provided in the draw solution bath 113 to induce the generation of osmotic pressure. The draw solution is a combination of a solvent (for example, water) and a draw solute, and the draw solute uses magnetic nanoparticles. In addition, in order to induce the osmotic pressure, the draw solution has a higher concentration than the waste water in the waste water bath 112. In this configuration, an osmotic pressure is generated between the waste water and the draw solution, and due to the osmotic pressure, the pure fluid, namely fresh water in the waste water moves to the draw solution bath 113, and only concentrated waste water remains in the waste water bath 112.

The draw solution concentration adjusting bath 120 plays a role of supplying a draw solution, which always has a consistent concentration, to the draw solution bath 113 of the forward osmosis membrane unit 110. If the forward osmosis membrane filtration process is performed by the forward osmosis membrane unit 110, waste water is separated into fresh water and concentrated waste water, and at this time, as the fresh water is transferred to the draw solution bath 113, the draw solution in the draw solution bath 113 is diluted to have a lowered concentration. If the concentration of the draw solution is lowered as described above, the osmotic pressure decreases. In order to prevent this, the concentration of the draw solution should be maintained consistently in the draw solution bath 113.

In order to control the draw solution to have a consistent concentration, the diluted draw solution needs to be supplemented with a draw solute, namely magnetic nanoparticles, to adjust the concentration of the draw solution. Specifically, in a state where the forward osmosis membrane filtration process is performed, the diluted draw solution in the draw solution bath 113 is supplied to the draw solution concentration adjusting bath 120, and magnetic nanoparticles are put into the draw solution concentration adjusting bath 120 to adjust the concentration of the draw solution. The draw solution with an adjusted concentration is put into the draw solution bath 113 of the forward osmosis membrane unit 110 again. At this time, the magnetic nanoparticles are supplied from the magnetic nanoparticles recovery apparatus 130, explained below.

The magnetic nanoparticles recovery apparatus 130 receives a draw solution from the draw solution concentration adjusting bath 120 and recovers magnetic nanoparticles included in the corresponding draw solution. As the magnetic nanoparticles are recovered from the draw solution, fresh water is naturally separated.

The magnetic nanoparticles recovery apparatus 130 includes a draw solution transfer pipe 131 and a magnetic field applying unit. The draw solution transfer pipe 131 is used for transferring the draw solution supplied from the draw solution concentration adjusting bath 120, and the magnetic field applying unit is provided at the circumference of the draw solution transfer pipe 131 to selectively apply a magnetic field to the draw solution transfer pipe 131. As a magnetic field is selectively applied by the magnetic field applying unit, the magnetic nanoparticles in the draw solution may be attached to or detached from the inner wall of the draw solution transfer pipe 131.

The magnetic field applying unit may include a magnetic body case 132 and a magnetic body 133. The magnetic body 133 is provided in the magnetic body case 132, and in the magnetic body case 132, the magnetic body 133 may be provided at different locations. In other words, the magnetic body 133 may be provided at a location (first location) adjacent to the draw solution transfer pipe 131 or a location (second location) apart from the draw solution transfer pipe 131. As another embodiment, without changing a location of the magnetic body 133 of the magnetic body case 132, the magnetic body 133 may be fixed in the magnetic body case 132 and the magnetic body case 132 may rotate by 180 degrees, so that the rotation of the magnetic body case 132 may adjust a distance between the draw solution transfer pipe 131 and the magnetic body 133. In addition, a fresh water discharge line for discharging the fresh water and a magnetic nanoparticles collection line for recovering the magnetic nanoparticles are provided at the lower portion of the draw solution transfer pipe 131, and valves are respectively provided to the fresh water discharge line and the magnetic nanoparticles collection line.

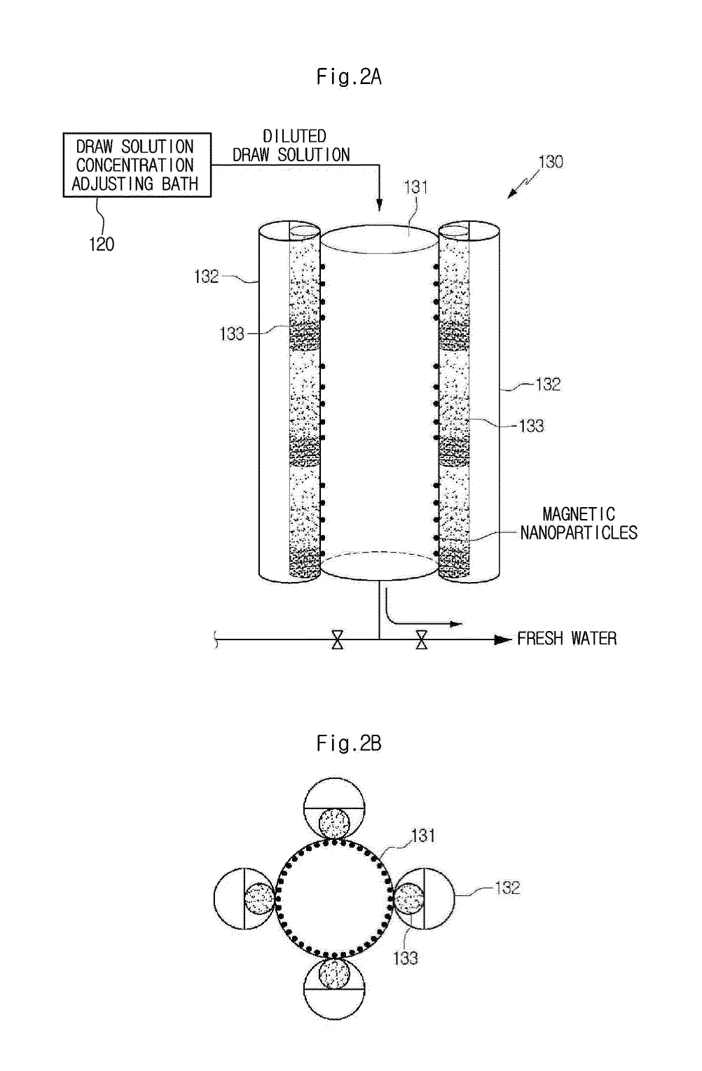

In this configuration, the method for the magnetic nanoparticles recovery apparatus 130 to recover magnetic nanoparticles and separate fresh water will be described below. First, as shown in FIGS. 2a and 2b, in a state where the magnetic body 133 is provided at the first location adjacent to the draw solution transfer pipe 131, if a certain amount of draw solution is supplied from the draw solution concentration adjusting bath 120 to the draw solution transfer pipe 131, the magnetic nanoparticles in the draw solution are attached to the inner wall of the draw solution transfer pipe 131 due to the magnetic field of the magnetic body 133. Therefore, the draw solution is separated into magnetic nanoparticles and fresh water, and the separated fresh water discharges along the fresh water discharge line. At this time, the magnetic nanoparticles collection line keeps locked by the valve. This process may be called a fresh water separating process. Meanwhile, an ion exchange resin 140 may be further provided at the rear end of the fresh water discharge line to remove magnetic ion remaining in the fresh water.

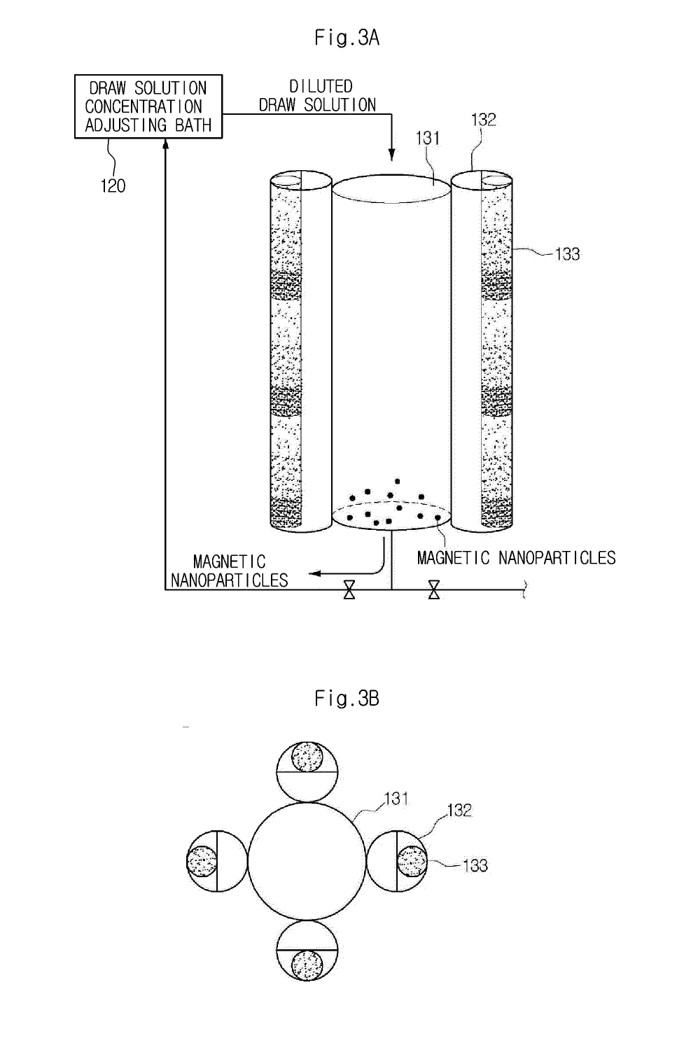

In a state where the fresh water separating process is completed, as shown in FIGS. 3a and 3b, the magnetic body 133 is provided at a position apart from the draw solution transfer pipe 131 to the maximum, namely at the second location, and subsequently a certain amount of draw solution is supplied from the draw solution concentration adjusting bath 120 to the draw solution transfer pipe 131. Accordingly, the magnetic nanoparticles in the draw solution transfer pipe 131 is swept by the draw solution and transferred along the magnetic nanoparticles collection line to the draw solution concentration adjusting bath 120. At this time, the fresh water discharge line keeps being locked by the valve. This process may be called a magnetic nanoparticles recovering process, and as the magnetic nanoparticles are supplied along the magnetic nanoparticles collection line to the draw solution concentration adjusting bath 120, the concentration of the diluted draw solution in the draw solution concentration adjusting bath 120 may be increased.

Even though FIG. 1 shows that a single magnetic nanoparticles recovery apparatus is provided, a plurality of magnetic nanoparticles recovery apparatuses may also be provided. For example, in a case where two magnetic nanoparticles recovery apparatuses are provided, a first magnetic nanoparticles recovery apparatus and a second magnetic nanoparticles recovery apparatus may perform a fresh water separating process and a magnetic nanoparticles recovering process alternately. In other words, in a case where the first magnetic nanoparticles recovery apparatus performs the fresh water separating process, the second magnetic nanoparticles recovery apparatus performs the magnetic nanoparticles recovering process, and if the first magnetic nanoparticles recovery apparatus completes the fresh water separating process and then performs the magnetic nanoparticles recovering process, the second magnetic nanoparticles recovery apparatus also completes the magnetic nanoparticles recovering process and then performs the fresh water separating process. If a plurality of magnetic nanoparticles recovery apparatuses are provided as described above, the fresh water separating process and the magnetic nanoparticles recovering process may be performed successively. In this case, each process requires opening or closing a corresponding valve (as described above).

In the present disclosure, even though the magnetic nanoparticles recovery apparatus has been illustrated as being applied to a forward osmosis filtration membrane apparatus, the magnetic nanoparticles recovery apparatus may be applied to any processes for recovering and reusing magnetic nanoparticles.

Heretofore, the apparatus for forward osmosis membrane filtration using the magnetic nanoparticles recovery apparatus according to an embodiment of the present disclosure has been described. Hereinafter, a method for forward osmosis membrane filtration using the magnetic nanoparticles recovery apparatus according to an embodiment of the present disclosure will be described.

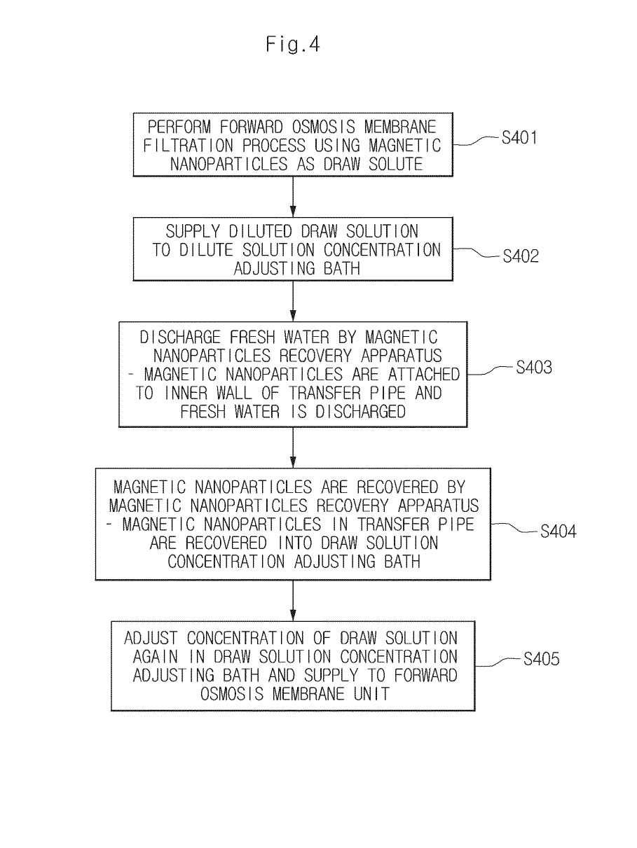

First, as shown in FIG. 4, the forward osmosis membrane filtration process is performed by means of the forward osmosis membrane unit 110 (S401). Specifically, in a state where the waste water bath 112 and the draw solution bath 113 are provided with the forward osmosis membrane 111 being interposed therebetween, waste water is separated into fresh water and concentrated waste water due to an osmotic pressure, and the fresh water is transferred to the draw solution bath 113.

The draw solution in the draw solution bath 113 is diluted through the forward osmosis membrane filtration process, and the diluted draw solution is supplied to the draw solution concentration adjusting bath 120 (S402).

Subsequently, the magnetic nanoparticles recovering process and the separated water discharging process are performed. As a first process, in a state where the magnetic body 133 is adjacent to the draw solution transfer pipe 131, if the draw solution of the draw solution concentration adjusting bath 120 is supplied to the draw solution transfer pipe 131, the magnetic nanoparticles are attached to the inner wall of the draw solution transfer pipe 131, and the fresh water free from magnetic nanoparticles is discharged along the fresh water discharge line (S403). Subsequently, as a second process, in a state where the magnetic body 133 is provided at a location apart from the draw solution transfer pipe 131, if the draw solution of the draw solution concentration adjusting bath 120 is supplied to the draw solution transfer pipe 131, the magnetic nanoparticles filtered in the first process are swept by the draw solution and recovered along the magnetic nanoparticles collection line, and the recovered magnetic nanoparticles are transferred to the draw solution concentration adjusting bath 120 (S404).

As the magnetic nanoparticles are supplied to the draw solution concentration adjusting bath 120, the concentration of the draw solution in the draw solution concentration adjusting bath 120 increases, and the draw solution with an increased concentration may be supplied to the draw solution bath 113 of the forward osmosis membrane unit 110 so that the concentration of the draw solution in the draw solution bath 113 may be consistently maintained (S405).

Meanwhile, when the magnetic nanoparticles are recovered, the density of magnetic nanoparticles in the draw solution is great at an inlet portion of the draw solution transfer pipe 131, and the density of magnetic nanoparticles in the draw solution is small at a discharging portion of the draw solution transfer pipe 131. Therefore, the magnetic body 133 may have relatively lower magnetic intensity at an inlet portion of the draw solution transfer pipe 131 and relatively higher magnetic intensity at a discharging portion of the draw solution transfer pipe 131. For reference, FIG. 1 depicts that the draw solution flows in at the upper portion of the draw solution transfer pipe 131 and discharges through the lower portion of the draw solution transfer pipe 131, and vice versa.

While the exemplary embodiments have been shown and described, it will be understood by those skilled in the art that various changes in form and details may be made thereto without departing from the spirit and scope of the present disclosure as defined by the appended claims.

What is claimed is:

1. An apparatus for recovery of magnetic nanoparticles, comprising:
a draw solution transfer pipe for transferring a solution containing magnetic nanoparticles; and
a magnetic field applying unit provided at the circumference of the draw solution transfer pipe to selectively apply a magnetic field thereto so that the magnetic nanoparticles in the draw solution are attached to or detached from the draw solution transfer pipe,
wherein the magnetic field applying unit includes a magnetic body case provided to closely adhere to an outer wall of the draw solution transfer pipe and a magnetic body provided in the magnetic body case, and
wherein the magnetic body is provided at a location adjacent to the draw solution transfer pipe to attach the magnetic nanoparticles in the draw solution to an inner wall of the draw solution transfer pipe or provided at a location apart from the draw solution transfer pipe to detach the magnetic nanoparticles attached to the inner wall of the draw solution transfer pipe.

2. The apparatus for recovery of magnetic nanoparticles according to claim 1, wherein the magnetic body is fixed in the magnetic body case, the magnetic body case is rotatable by 180 degrees, and the rotation of the magnetic body case allows the magnetic body to be located adjacent to the draw solution transfer pipe or be located apart from the draw solution transfer pipe.

3. The apparatus for recovery of magnetic nanoparticles according to claim 1, wherein a fresh water discharge line for discharging fresh water obtained by removing the magnetic nanoparticles from the draw solution and a magnetic nanoparticles collection line for recovering the magnetic nanoparticles are further provided at one side of the draw solution transfer pipe.

4. The apparatus for recovery of magnetic nanoparticles according to claim 1, wherein the apparatus selectively performs:
a fresh water discharging process of supplying a draw solution to the draw solution transfer pipe in a state where a magnetic field is applied to the draw solution transfer pipe so as to attach magnetic nanoparticles in the draw solution to the inner wall of the draw solution transfer pipe and discharge the fresh water, and
a magnetic nanoparticles recovering process for supplying a draw solution to the draw solution transfer pipe in a state where a magnetic field applied to the draw solution transfer pipe is removed so as to recover the magnetic nanoparticles.

5. An apparatus for forward osmosis membrane filtration using a magnetic nanoparticles recovery apparatus, the apparatus comprising:
a forward osmosis membrane unit for separating waste water into fresh water and concentrated waste water by using magnetic nanoparticles as a draw solute of a draw solution;
a draw solution concentration adjusting bath for receiving a diluted draw solution from the forward osmosis membrane unit, putting magnetic nanoparticles into the diluted draw solution to adjust a concentration of the draw solution, and re-supplying the draw solution to a draw solution bath of the forward osmosis membrane unit; and
a magnetic nanoparticles recovery apparatus for receiving a diluted draw solution from the draw solution concentration adjusting bath, separating the draw solution into magnetic nanoparticles and fresh water, recovering the separated magnetic nanoparticles, and supplying the recovered magnetic nanoparticles to the draw solution concentration adjusting bath.

6. The apparatus for forward osmosis membrane filtration using a magnetic nanoparticles recovery apparatus according to claim 5, wherein the magnetic nanoparticles recovery apparatus includes:
a draw solution transfer pipe for transferring a diluted draw solution supplied from the draw solution concentration adjusting bath; and
a magnetic field applying unit provided at the circumference of the draw solution transfer pipe to selectively apply a magnetic field thereto so that the magnetic nanoparticles in the draw solution are attached to or detached from the draw solution transfer pipe.

7. The apparatus for forward osmosis membrane filtration using a magnetic nanoparticles recovery apparatus according to claim 6,
wherein the magnetic field applying unit includes a magnetic body case provided to closely adhere to an outer wall of the draw solution transfer pipe and a magnetic body provided in the magnetic body case, and
wherein the magnetic body is provided at a location adjacent to the draw solution transfer pipe to attach the magnetic nanoparticles in the draw solution to an inner wall of the draw solution transfer pipe or provided at a location apart from the draw solution transfer pipe to detach the magnetic nanoparticles attached to the inner wall of the draw solution transfer pipe.

8. The apparatus for forward osmosis membrane filtration using a magnetic nanoparticles recovery apparatus according to claim 7, wherein the magnetic body is fixed in the magnetic body case, the magnetic body case is rotatable by 180 degrees, and the rotation of the magnetic body case allows the magnetic body to be located adjacent to the draw solution transfer pipe or be located apart from the draw solution transfer pipe.

9. The apparatus for forward osmosis membrane filtration using a magnetic nanoparticles recovery apparatus according to claim 6, wherein a fresh water discharge line for discharging fresh water obtained by removing the magnetic nanoparticles from the draw solution and a magnetic nanoparticles collection line for recovering the magnetic nanoparticles are further provided at one side of the draw solution transfer pipe.

10. The apparatus for forward osmosis membrane filtration using a magnetic nanoparticles recovery apparatus according to claim 9, further comprising an ion exchange resin provided at the rear end of the fresh water discharge line to remove magnetic ion remaining in the fresh water.

11. The apparatus for forward osmosis membrane filtration using a magnetic nanoparticles recovery apparatus according to claim 7, wherein the magnetic body is configured so that the magnetic body has relatively lower magnetic intensity at an inlet portion of the draw solution transfer pipe and relatively higher magnetic intensity at a discharging portion of the draw solution transfer pipe.

12. The apparatus for forward osmosis membrane filtration using a magnetic nanoparticles recovery apparatus according to claim 5, wherein the apparatus comprises a plurality of magnetic nanoparticles recovery apparatuses, and each magnetic nanoparticles recovery apparatus alternately performs a <fresh water separating process> of separating a draw solution into magnetic nanoparticles and fresh water and a <magnetic nanoparticles recovering process> of recovering the separated magnetic nanoparticles and supplying the recovered magnetic nanoparticles to the draw solution concentration adjusting bath.

13. A method for forward osmosis membrane filtration using a magnetic nanoparticles recovery apparatus, the method comprising:
performing a forward osmosis membrane filtration process by means of a forward osmosis membrane unit which uses magnetic nanoparticles as a draw solute;
supplying a draw solution diluted by the forward osmosis membrane filtration process to a draw solution concentration adjusting bath;
supplying the draw solution of the draw solution concentration adjusting bath to a magnetic nanoparticles recovery apparatus, and separating the draw solution into fresh water and magnetic nanoparticles by means of the magnetic nanoparticles recovery apparatus; and
adjusting a concentration of the draw solution by putting the magnetic nanoparticles recovered by the magnetic nanoparticles recovery apparatus into the draw solution concentration adjusting bath, and supplying the adjusted draw solution to a draw solution bath of the forward osmosis membrane unit.

14. The method for forward osmosis membrane filtration using a magnetic nanoparticles recovery apparatus according to claim 13,
wherein the magnetic nanoparticles recovery apparatus includes a draw solution transfer pipe and a magnetic field applying unit, and
wherein said separating of the draw solution into fresh water and magnetic nanoparticles by means of the magnetic nanoparticles recovery apparatus includes:
a fresh water discharging process of supplying a draw solution from the draw solution concentration adjusting bath to the draw solution transfer pipe in a state where a magnetic field is applied to the draw solution transfer pipe so as to attach magnetic nanoparticles in the draw solution to the inner wall of the draw solution transfer pipe and discharge the fresh water, and
a magnetic nanoparticles recovering process for supplying a draw solution from the draw solution concentration adjusting bath to the draw solution transfer pipe in a state where a magnetic field applied to the draw solution transfer pipe is removed so as to recover the magnetic nanoparticles.

15. The method for forward osmosis membrane filtration using a magnetic nanoparticles recovery apparatus according to claim 13, further comprising:
removing magnetic ion remaining in the fresh water, separated by the magnetic nanoparticles recovery apparatus, by means of an ion exchange resin.
